(19) United States
(12) Patent Application Publication
(10) Pub. No.: US 2021/0256393 A1
(43) Pub. Date: Aug. 19, 2021

(54) SYSTEM AND METHOD FOR DISTRIBUTED NON-LINEAR MASKING OF SENSITIVE DATA FOR MACHINE LEARNING TRAINING

(71) Applicant: ROYAL BANK OF CANADA, Toronto (CA)

(72) Inventors: Ehsan AMJADIAN, Toronto (CA); Danny HUI, Toronto (CA)

(21) Appl. No.: 17/179,355

(22) Filed: Feb. 18, 2021

Related U.S. Application Data
(60) Provisional application No. 62/978,066, filed on Feb. 18, 2020.

(51) Int. Cl. G06N 3/08; G06N 3/04; H04L 29/06

(52) U.S. Cl. CPC G06N 3/088; H04L 63/083; G06N 3/0454

(57) ABSTRACT

Described in various embodiments herein is a technical solution directed to training downstream machine learning models. In particular, specific machines, computer-readable media, computer processes, and methods are described that are utilized to improve data security during training downstream machine learning models, including decreasing the risk of unauthorized access of training data, decreasing the risk of unauthorized use of training data by authorized users, increasing system systemic speed, and reduced overall computational resource requirements. Training data is manipulated prior to being provided for training machine learning models.

### CROSS-REFERENCE TO RELATED APPLICATIONS

The present application claims priority to and the benefit of U.S. Provisional Application No. 62/978,066 entitled SYSTEM AND METHOD FOR DISTRIBUTED NON-LINEAR MASKING OF SENSITIVE DATA FOR MACHINE LEARNING TRAINING, the entire contents of which is hereby incorporated by reference.

### FIELD

The present disclosure generally relates to the field of machine learning, and more specifically, to systems and methods training machine learning models and data masking.

### INTRODUCTION

Machine learning models can require access to large sets of data in order to be trained to provide useful or improved results. Large sets of data used to train machine learning models can include sensitive data. There may be increased attention to data security, data privacy, and data access rights to sensitive data stored by or controlled by organizations. There exists a need for systems and methods of protecting the sensitive data against potential intrusions.

Large sets of data used to train machine learning models may be protected against intrusions using an encryption scheme. Protection techniques may detokenize or decrypt data within the large data sets at a column or cell level.

Encryption schemes operating with access to local resources can involve encryption and decryption of data using local computing resources. However, there may be insufficient computing power or economical computing resources available for such encryption processes. Cloud computing resources which, due to the increased scale of computing resources, may provide potential cost-efficiency and greater computational resource availability.

For encryption schemes, the data needs to be decrypted on the cloud before a machine learning model can be trained on the encrypted data. Decrypting the data poses risks, including, for example, bad actors accessing the resource and seeing the sensitive data, or through actors permitted to access the sensitive data scientist misusing their authority to access sensitive data for nefarious purposes.

There is need for systems and methods of training machine learning models, including with access to cloud computing resources that protects sensitive data against potential intrusions.

### SUMMARY

In an aspect, there is provided a system for training a machine learning model. The system comprises a first system (e.g. a cloud computing system) comprising a first computer processor operating in conjunction with a first computer memory. The first computer processor is configured to receive a first data set (e.g. banking data), and to transmit a first request based on the first data set to a second system. The second system comprises a second computer processor operating in conjunction with a second computer memory, and is configured to train a machine learning model based on an encoded first data set, the encoded data set being based on the first data set. The second computer processor stores a second data set representing the trained machine learning model to the second computer memory. The trained machine learning model can be used to generate output data for predictions and classifications, for example.

In example embodiments, the first request comprises the encoded first data set, and the first computer processor is configured to generate a first encoder configured with the first relationship machine learning model to generate encoded data sets based on raw data sets. The encoded data sets can preserve data interrelationships within the raw data sets. The first computer processor is configured to generate a first decoder configured with a first relationship machine learning model to decode data encoded by the encoder. The first computer processor is further configured to generate the encoded first data set based on the first data set passing through the first encoder. The first computer processor stores a third data set representing the first encoder and the first decoder in the first computer memory.

In example embodiments, the second computer processor is configured to generate the first encoder configured with the first relationship machine learning model which generates encoded data sets based on raw data sets, the encoded data sets preserving data interrelationships within the raw data sets, and to generate the first decoder, configured with a first relationship machine learning model to decode data encoded by the encoder. Upon receiving the first request comprising the first data set, the second computer processor generates the encoded first data set based on the first data set passing through the first encoder. The second computer processor stores the third data set representing the first encoder and the first decoder in the second computer memory.

In example embodiments, the second computer processor encrypts the encoded first data set, and in response to receiving an authenticated request to train a machine learning model, decrypts the encrypted encoded first data set.

In example embodiments, encrypting the encoded first data set comprises transmitting a request for a first security key, for example to a key vault, receiving the first security key, and encrypting the encoded first data set based on the first security key. Decrypting the encrypted encoded first data set comprises transmitting a request for a second security key, for example to the key vault, the second security key configured to decrypt data encrypted with the first security key, receiving the second security key, and decrypting the encrypted encoded first data set based on the second security key.

In example embodiments, the first computer processor is configured to transmit the third data set to the second system, and the second computer processor is configured to receive a second input data set, and encode the second input data set with the first encoder to generate an encoded second input data set. The second computer processor is further configured to pass the encoded second input data set through the trained machine learning model to generate a second processed response, and store the second processed response.

In example embodiments, the second computer processor is configured to transmit the second processed response.

The systems are implemented using computing devices having a combination of software and hardware, or embedded firmware. The computing devices are electronic devices that include processors (e.g., hardware computer processors), and computer memory, and operate in conjunction with data storage, which may be local or remote. Software may be affixed in the form of machine-interpretable instructions stored on non-transitory computer readable media, which cause a processor to perform steps of a method upon execution.

In some embodiments, the computing devices are specially adapted special purpose machines, such as rack server appliances, that are configured to be installed within data centers and adapted for interconnection with back-end data sources for generating and/or maintaining one or more data structures representing the machine learning architectures associated with one or more corresponding user profiles. The special purpose machines, for example, may have high performance encoding or encrypting data.

The trained machine learning data model architectures are maintained on a data storage and stored for usage. The trained machine learning data model architectures can be deployed to generate predictions based on new data sets provided as inputs. The predictions are generated through passing the inputs through the various layers (e.g., gates) and interconnections such that an output is generated that is an output data element. An output data element can be captured as a data structure, and can include generated logits/softmax outputs such as prediction data structures. Generated predictions, for example, can include estimated classifications (e.g., what type of animal is this), estimated values (e.g., what is the price of bananas on Nov. 21, 2025).

The encoded data can represent, for example, banking data, patient data or other personal health data, or any data for which an organization is responsible.

In another aspect there is provided a computer-implemented method for training a machine learning model. The method comprises training a machine learning model based on an encoded first data set. The encoded first data set may be encoded based on a first relationship machine learning model, the first relationship machine learning model configured to generate encoded data sets based on raw data sets, with the encoded data sets preserving data interrelationships within the raw data sets. The method may further comprise storing a second data set representing the trained machine learning model.

In example embodiments, the method of further comprises encrypting the encoded first data set, and in response to receiving an authenticated request to train a machine learning model, decrypting the encrypted encoded first data set.

In example embodiments, encrypting the encoded first data set comprises transmitting a request for a first security key, receiving the first security key, and encrypting the encoded first data set based on the first security key.

In example embodiments, decrypting the encrypted encoded first data set comprises transmitting a request for a second security key, the second security key configured to decrypt data encrypted with the first security key, and receiving the second security key. The encrypted encoded first data set is decrypted based on the second security key.

In example embodiments, the method further comprises receiving a third data set representing a first encoder configured with the first relationship machine learning model, a first decoder, configured with a paired first relationship machine learning model to decode data encoded by the first encoder, and storing the third data set. In example embodiments, the method further comprises receiving a first data set, and encoding the first data set with the first encoder to generate the encoded first data set.

In example embodiments, the method further comprises generating a first encoder configured with the first relationship machine learning model to generate encoded data sets based on raw data sets, the encoded data sets preserving data interrelationships within the raw data sets, generating a first decoder, configured with a paired first relationship machine learning model to decode data encoded by the encoder, and storing a third data set representing the first encoder and the first decoder.

In example embodiments, the method further comprises transmitting the third data set and the second data set in response to an authenticated request.

In another aspect there is provided a computer-implemented method, the method comprising receiving a second request comprising input data, generating encoded input data based on a second relationship machine learning model and the input data, the second relationship machine learning model configured to generate encoded data that interfaces with machine learning models trained on data encoded based on a first relationship machine learning model, transmitting a first request comprising the encoded input data, receiving a first response comprising processed response data, the processed response data generated based on the encoded input data passing through a machine learning model trained on data encoded based on the first relationship machine learning model, and decoding the processed response data based on the second relationship machine learning model.

In example embodiments, generating encoded input data based on a second relationship machine learning model and the input data further comprises generating a second encoder configured to encode data based on the second relationship machine learning model, generating the second encoder simultaneously with generating a second decoder, the second decoder configured to decode data encoded by the second encoder based on the first relationship machine learning model, and storing a fourth data set representing the second encoder and the second decoder.

In another aspect there is provided a computer-implemented method for a server system having machine learning models. The method involves generating an encoder using a hardware processor accessing a first relationship machine learning model from non-transitory memory, the first relationship machine learning model being an encoder and decoder model to generate encoded data sets based on raw data sets, the encoded data sets preserving data interrelationships within the raw data sets, the encoder for non-linear masking. The method involves storing the encoder in an encoder repository on non-transitory storage. The method involves encoding a first data set using the encoder to generate an encoded first data set based on the first relationship machine learning model. The method involves storing the encoded first data set in cloud storage. The method involves training a machine learning model based on the encoded first data set using a hardware server to access the encoded first data set stored in the cloud storage. The method involves storing the trained machine learning model in a model repository.

In some embodiments, the method further involves encrypting the encoded first data set. In some embodiments, the method involves encrypting the encoded first data set by: transmitting a request for a first security key, receiving the first security key, and encrypting the encoded first data set based on the first security key.

In some embodiments, in response to receiving an authenticated request to train the machine learning model, the method further involves decrypting the encrypted encoded first data set. In some embodiments, decrypting the encrypted encoded first data set involves: transmitting a request for a second security key, the second security key configured to decrypt data encrypted with the first security key, receiving the second security key, and decrypting the encrypted encoded first data set based on the second security key.

In some embodiments, the method further involves generating the first relationship machine learning model as the encoder and decoder model; generating a first encoder configured with the first relationship machine learning model, and a first decoder, configured with a paired first relationship machine learning model to decode data encoded by the first encoder; and encoding a first data set with the first encoder to generate the encoded first data set.

In some embodiments, the method further involves generating a first encoder configured with the first relationship machine learning model to generate encoded data sets based on raw data sets, the encoded data sets preserving data interrelationships within the raw data sets, generating a first decoder, configured with a paired first relationship machine learning model to decode data encoded by the encoder, and storing the first encoder and the first decoder.

In some embodiments, the method further involves transmitting the third data set and the second data set in response to an authenticated request.

In some embodiments, the method further involves encoding a second data set using the encoder to generate an encoded second data set based on the first relationship machine learning model; storing the encoded second data set in the cloud storage; and training the machine learning model based on the encoded second data set.

In some embodiments, the method further involves encoding input data using the encoder to generate encoded input data, wherein the encoder repository has service interface to access the encoder; generating output data by processing the encoded input data using the trained machine learning model, wherein the model repository has an application programming interface to access the trained machine learning model; and making a prediction or acting on the output data using an application.

In another aspect there is provided a computer-implemented method for a server system training machine learning models. The method involves generating an encoder using a first relationship machine learning model, the first relationship machine learning model being an encoder and decoder model to generate encoded data sets based on raw data sets, the encoded data sets preserving data interrelationships within the raw data sets, the encoder for non-linear masking; storing the encoder in an encoder repository on non-transitory storage; encoding a plurality of data sets using the encoder to generate a plurality of encoded data sets based on the first relationship machine learning model; storing the plurality of data sets in cloud storage; training a machine learning model based on the plurality of data sets; storing the trained machine learning model in a model repository.

In another aspect there is provided a server system for machine learning models. The system involves a hardware processor operating in conjunction with non-transitory memory. The hardware processor: receives a plurality of encoded data sets generated by an encoder using a first relationship machine learning model, the first relationship machine learning model being an encoder and decoder model to generate encoded data sets based on raw data sets, the encoded data sets preserving data interrelationships within the raw data sets, the encoder for non-linear masking; stores the plurality of encoded data sets on cloud storage; trains a machine learning model using the encoded data set by accessing the cloud storage; and stores the trained machine learning model to a model repository, the model repository having an interface to enable access and use of the trained machine learning model to generate output data.

In another aspect there is provided a server system for machine learning models. The system involves a hardware processor operating in conjunction with non-transitory memory. The hardware processor: receives an encoded data set generated by an encoder using a first relationship machine learning model, the first relationship machine learning model being an encoder and decoder model to generate encoded data sets based on raw data sets, the encoded data sets preserving data interrelationships within the raw data sets, the encoder for non-linear masking; trains a machine learning model using the encoded data set; and stores the trained machine learning model to a model repository, the model repository having an interface to enable access and use of the trained machine learning model to generate output data.

In some embodiments, the other computer system encodes input data using the encoder to generate encoded input data, and generates output data by the processing the encoded input data using the trained machine learning model.

In some embodiments, the hardware processor: generates the encoder configured with the first relationship machine learning model to generate encoded data sets based on raw data sets, the encoded data sets preserving data interrelationships within the raw data sets; generates a decoder configured with a paired first relationship machine learning model to decode data encoded by the encoder; generates the encoded first data set by processing the data set using the encoder, and stores the encoder and the decoder.

In various further aspects, the disclosure provides corresponding systems and devices, and logic structures such as machine-executable coded instruction sets for implementing such systems, devices, and methods.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein:

FIG. 1 shows an example process diagram for generating encoded data, according to some embodiments.

FIG. 2 shows an example diagram of relationship mapping during encoding, according to some embodiments;

FIG. 3 shows an example diagram for training machine learning models on encoded data, according to some embodiments;

FIG. 4 shows an example diagram for providing access to machine learning models trained on encoded data, according to some embodiments;

FIG. 5 shows an example diagram for generating processed data from machine learning models trained on encoded data, according to some embodiments;

FIG. 6 is a block schematic of an example system, according to some embodiments;

FIG. 7 is an example method diagram for generating machine learning models trained on encoded data, according to some embodiments;

FIG. 8 is an example method diagram for generating processed data from machine learning models trained on encoded data, according to some embodiments;

FIG. 9 shows an example architecture of an encoder key, according to some embodiments;

FIG. 10 shows an example architecture of an encoder key with expanded nested layers, according to some embodiments;

FIG. 11 shows an example architecture of a decoder key that corresponds to the example encoder key; and

FIG. 12 shows an example architecture of a decoder key with expanded nested layers that corresponds to the example encoder key.

### DETAILED DESCRIPTION

Systems and methods for training machine learning models are described herein in various embodiments. Protecting sensitive data against potential intrusions is desirable. Sensitive data can be alternatively referred to herein as raw data. Protection methods evolve over time (e.g., as encryption schemes are rendered ineffective).

The effective training of machine learning models while maintaining adequate security of the underlying data raises technical challenges for machine learning approaches. There are technical challenges when the data to be provided to the machine learning model is to be stored on a set of distributed computing resources (e.g., the “cloud”), which may, in some embodiments, be residing on an off-premises data center (e.g., for economies of scale).

For example, the machine learning model may itself be stored on the set of distributed computing resources, which allows the machine learning model to access more readily and more efficiently the resources of the set of distributed computing resources (e.g., the ability to “spin up” and “spin down” computing resources on demand). However, an organization may not trust the set of distributed computing resources, especially if off-premises or out of the control of the organization. There exists a need to ensure that cybersecurity or physical security requirements are maintained.

Approaches for improving system security, which rely upon encryption schemes, may derive reliability from the encryption scheme used to protect the sensitive data. Breaches of the encryption scheme may not be discovered for extended periods of time, leading to a scope and scale of potential exposure of data which may be difficult to determine after the fact.

Encryption schemes may also require constant updating, or expensive maintenance services in order to implement. Encryption schemes can introduce unacceptable limitations to timely access to data through the introduction of protocols requiring a delay period or requiring lengthy computational operations.

Embodiments described herein involve training machine learning models using sensitive or raw data that has been encoded, and may also involve storing encoded raw data for training on a cloud platform. This may reduce the risk of data intrusion as a result of storing raw data for training on a cloud platform.

In some embodiments, some of the approaches described herein propose a method of training machine learning models based on encoded data, as compared to training the machine learning models on raw data. The data can be encoded, as described, to obfuscate or otherwise transform the data (e.g., using non-linear masking) such that the underlying raw data (sensitive data) is difficult or practically impossible to regenerate from the encoded data. For example, the non-linear encoding may introduce noise such that a same value being encoded twice may have two different output values.

Encoded data may comprise data that has been encoded by an encoder based on a first relationship machine learning model. A first relationship machine learning model may generate encoded data sets based on raw or unencoded data sets, The encoded data sets preserve data interrelationships within the raw or unencoded data sets. The relationship machine learning model preserves the relationships in encoded data and does not impact performance for model training using the encoded data.

Raw data is unencoded data. Decoded data is data that has been processed by an encoder and decoder. Raw data, as used herein, may refer to not only the data that is in its original form but data that has not gone through any encoding (e.g., by an autoencoder) and decoding process (e.g., by a decoder). In contrast, decoded data may look exactly or approximately very similar to the original raw data but it has gone through both the encoded and decoder. For example, decoded data refers to the data coming out of the decoder key that decrypts the encoded data to a human understandable format.

The following is a financial data example of encoded data and raw data:

| | |
|---|---|
| 0.252470669 | $300 |
| 0.290304943 | $400 |
| 0.08957369 | $9,876 |
| 0.104851771 | $1,500 |
| 0.421311574 | $100 |

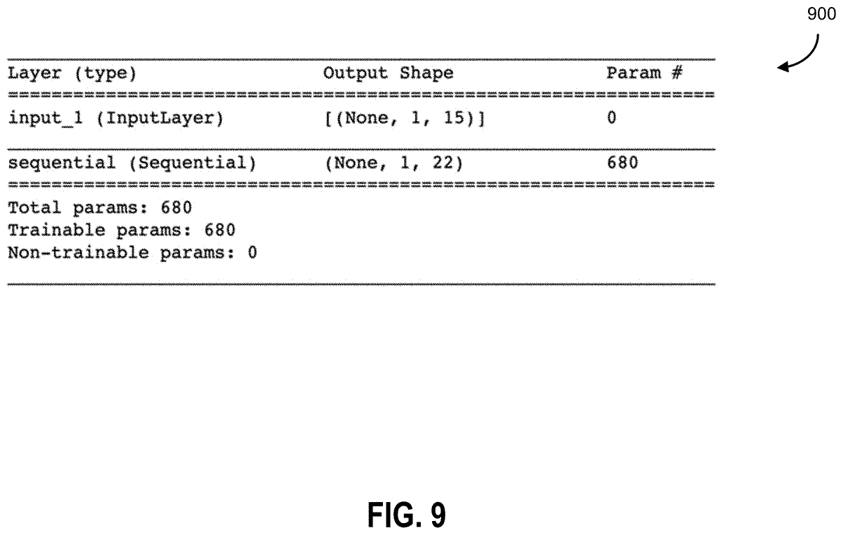

The encoder and decoder use layers of linear and non-linear transformations. The non-linearities can be performed by sigmoid, tanh, and ReLU functions, for example. These form a series of non-affine transformations which are less restrictive than their linear counterparts in the encoding task resulting in a higher degree of safeguarding the data. Example encoders and decoders are shown in FIGS. 9 to 12.

There are advantages from the usage of the autoencoder architecture as opposed to older dimensionality reduction methods for training. The autoencoder architecture is much less memory-intensive, which rids the process of the need to form a massive association matrix recording the occurrences of all the seen data points which is often infeasible in an industrial setting. Additionally, autoencoders can perform the non-linear masking without having to reduce dimensionality. This may be useful for cases where there is not enough bandwidth in a channel to warrant the adequacy of a bottleneck. In which case the hidden layers can even expand the channel (here the channel translates into the number of neurons in an intermediate layer) to ascertain efficient storage of all the information with minimal loss despite non-linearly masking the data.

The encoder may encode data in a non-linear manner, such that there is no linear relationship between the encoded and raw (unencoded) data. For example, the encoder may encode data such that each initial data entry is converted to a subsequent data entry representative of the initial data entry and the interrelation between the initial data entry and the remaining initial data entries. The encoded may implement different non-linear masking processes.

The encoded data transforms the raw data to obscure or mask the raw data. The encoded data transforms the sensitive data, for example. Thus the encoding transforms the data such that the encoded data may be safe to provide storage repositories, such as a less trustworthy form of storage (e.g., cloud storage on the set of distributed computing resources). This encoded data, without decoding, is then provided to the machine learning model for training. Accordingly, if the encoded data is stored on the set of distributed computing resources and the machine learning model is also hosted on set of distributed computing resources, even if a malicious third party obtains access to the set of distributed computing resources, the malicious third party is unable to access the underlying raw data as the malicious third party does not have the mechanism to reverse the decoding.

Embodiments described herein can build encoder keys and decoder keys for the non-linear masking architecture by using hardware processors to pass raw data and train the relationship model non-linearly transform it into a latent representation (which may be compressed but sometimes expanded as discussed). Embodiments described herein can reconstruct the input data out of the non-linearly masked latent representation. The former results in the encoder key and the latter results in the decoder key. The relationship model benefits from two cost functions. One Is the reconstruction loss which ensures the utmost proximity of the reconstructed data (decoded) to its raw counterpart. The other is the evidence lower bound of the KL divergence between the distribution of latent variables and the standard normal distribution. Due to this distributional nature of the algorithm as well as its reliance on optimization, the non-linear masking architecture can manifest minimal loss. For downstream machine learning models, the loss is either desirable (since it can add to the generalizability of the encoded information) or adds negligible variance. This is exemplified below by the shown numbers illustrating the performance of a highly accurate regressor trained 1. on raw data 2. on encoded data. There can be experiments for machine learning outcomes for both data encoded using a mask and data not encoded using a mask. The results of an example are shown below as an illustrative example.

1. The 70-30 train-test split of the dataset was performed (70% for training and 30% for testing).
2. The decision tree regressor was trained on the raw training dataset and was evaluated on the raw test dataset. Obtained R2 value: 0.99127 for the task.
3. The training dataset was encoded using a non-linear masking method. The decision tree regressor (same model) was trained on the encoded/masked training dataset and was subsequently, evaluated using the same encoded test dataset. Obtained R2 value: 0.99978 for the task.

It can be observed that the gap between the performance of the two experiments (encoded vs raw data) is minimal. In this example case, the model benefits from the encodings revealing patterns in the data. Therefore in this case the encoding is observed to contribute to the higher performance of the downstream model which is desirable. Accordingly, the proposed method of encoding data does not negatively impact model performance.

Decryption in a variety of applications of data science may be unnecessary. The use of encoded data may reduce the risk of exposure of raw data. Machine learning models that support a variety of business needs in various forms including predicting an outcome can use encoded data as training data. For example, data can include location data for transactions and customers, which can include spending data for different locations. The machine learning model can generate output data to predict location of spending and transaction for different customers. The trained machine learning model can generate the prediction data. There are different business applications for the trained machine learning models.

Example business applications include but are not limited to the following: cross cloud computing of data; sharing of data among different corporations; generating sub-sample of data for competitions and distributed training; commercialization of the data for other companies to reprocess; data storage with cost avoidance by compressing the data for storage less expensive potentially less secure sources; commercialization of models that are trained by the data, as they are derivatives and can be less potent compared to models trained on full set (e.g. there can be a sample version of model for further business development; cloud solutions for organizations to move data into cloud and leverage cloud hosted technology to do model training and analytics, reducing the difficulty of having cross business alignment for moving data into cloud; and generation of pretty good fake data that can be used for training on lower environments. These are illustrative example business applications.

These machine learning models, due to their statistical nature, do not require processing raw data. Such models can instead be built on an encoded version of the data that preserves the statistical signature of the information conveyed in the data but not the raw data itself. The statistical nature of the models do not require processing of raw data and the encoded data preserves the statistical signature of the data. During building, the encoder and decoder keys they are forced multiple times to non-linearly encode the data into values between −1 and −1, and decode them back into the original data as described herein. To do so they will inherently preserve statistical relations among the data points which enables the downstream machine learning model to utilize the encoded data points for prediction tasks without ever realizing what those data points refer to. These latent values however mask the raw data from malicious attackers.

The trained machine learning model can then be utilized to receive new data sets, which may be encoded similarly to the training data sets, and accordingly, the same transformation can be applied. The training data sets and the new data sets can be encoded using similar encoders or encoding process. The trained machine learning model may then generate output data sets, which can be encapsulated as output data structures. The output data structures can include output data for predictions or classifications. Example output data sets can include logits or normalized (e.g., using a Softmax) data values, which can then be utilized by a downstream system to generate predictions, classifications, among others.

In example embodiments, there is provided a system for distributed non-linear masking of sensitive data while retaining trainability for downstream machine learning models. The system involves encoders for non-linear masking of raw data to generate encoded data. The system can involve distributed components including a cloud storage for encrypted and encoded data. The system can involve a key vault for managing keys and a model repository of machine learning models for training on the encoded data. The system can output a trained machine learning model for storage in the model repository. The trained machine learning model can process new data to generate output data for predictions or classifications. The encoded data can mask the raw data to obscure sensitive data content, for example.

The encoding or masking method generates secure datasets as the output of the masking method by the encoder is encoded datasets. The system involves training machine learning models using the encoded datasets. The system can build or train the machine learning model without seeing the raw data as the encoded data is masked data. The system provides increased data security by building the machine learning models without actually seeing sensitive (raw) data. The system can use a distributed cloud infrastructure for storing encoded data. If an attacker gets access to the encoded data stored on the cloud they cannot access the sensitive (raw) data as the encoded data is masked and cannot be read. The system can use an encoder (e.g. autoencoder) as a form of securing the data. If an attacker were to access keys and decrypt stored encrypted data then the attacker would access encoded data which masks the sensitive, raw data. The attacker cannot access a decoder. The storage of encoded data provides improved security for the distributed system. The system can use an encoder to generate the encoded data. The system can use an encoder to reduce dimensionality of data. The encoded data has different data values than the raw data. The encoder change the values of the raw data. The system uses the encoder for the purpose of masking the raw data to secure the data. The system uses the encoded data for training the machine learning models. The system does not need to decode the encoded data in order to generate the trained models. The distributed system can process raw data, such as sensitive customer data, to generate encoded data. The system can store the new set of encoded data in a cloud storage repository. The system can use the encoded data to train a machine learning model. The system can then use the model to generate output data use for a prediction. The system can encode raw data sets from multiple parties or entities to generate a larger encoded data set and, accordingly, a larger training data set for machine learning models. The system can enable customers to share data if they use the same encoder to generate the encoded data set, for example. An encoder is used to generate the encoded data sets from the raw data sets. Encryption processes can change the values of raw data so that it cannot be used for training machine learning models. The encoder can transform the raw data into encoded datasets while preserving relationships in the data. The encoded data can be used for training machine learning models.

Before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

Accordingly, systems and methods adapted for learning user representations for training machine learning models are described herein in various embodiments. As described further, embodiments described herein involve training machine learning models by masking data (i.e. encoding data). The embodiments described herein solve technical problems and improve security as the potential means of unwanted access are constantly changing as encryption schemes are breached.

In some embodiments, some of the approaches described herein propose a method of training machine learning models based on encoded data. Encoded data may comprise (raw or sensitive) data that has been encoded by an encoder based on a first relationship machine learning model. The encoder processes or transforms the raw data to generate the encoded data. The first relationship machine learning model may generate encoded data sets based on raw or unencoded data sets. The encoded data sets preserve data interrelationships within the unencoded data sets. The encoder may encode data in a non-linear fashion, such that there is no linear relationship between the encoded data and raw (unencoded) data. For example, the encoded data may exhibit distributed non-linear features, thereby masking sensitive unencoded or raw data while retaining trainability for downstream machine learning models.

For downstream machine learning models, the exact format, values, and quantities of the data points may be irrelevant. For instance, the input vector [0.0001, 0.23, 0.0034] can specify the same concept as the vector [2, 3000, 4980] in a different vector space. Therefore as long as the relations between the hyper-dimensional data points are kept within the specific vector space (the space of all the data points of a problem set in addition to valid unseen data points), the specifics of a single data point, its format, or the values do no have an effect on the performance of the downstream machine learning model. In other words, a data point in singularity bears no information at all to the downstream machine learning model and is only meaningful in its statistical relationships to other data points, which are preserved in our masking practice. This property is beneficial such that we can transform the data points (the process referred to as non-linearly masking) so the data is unusable to potential malicious attackers but just as useful as the original (raw) data to downstream modeling tasks. Accordingly, the relationship machine learning model preserves the relationships in encoded data.

Training data, when passed through an auto encoder, can generate an encoder and decoder pair configured based on the training data. The encoder and decoder may be configured to, via encoding and decoding, respectively, preserve data interrelationships despite the encoded and decoded data not exhibiting relationships. Therefore, encoded training data preserves the beneficial interrelationships within training data, while potentially reducing available known methods for decoding the data as decoding may require either the paired decoder or the data set and auto encoder. The system uses the encoder and decoder pair to preserve the relationships in training data.

Approaches to securing training data that rely solely on encryption keys can involve exposing potentially sensitive data as the training machine learning models uses unencrypted data. The secured encrypted data is encrypted prior to training of the machine learning models thus exposing the raw data.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

Embodiments herein are implemented using a combination of electronic or computer hardware and/or software, such as processors, circuit boards, circuits, data storage devices, memory. The embodiments described may comprise various types of machine learning model architectures and topologies, such as data architectures adapted for supervised learning, reinforcement learning, among others.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein.

Moreover, the scope of the present application is not intended to be limited to the particular embodiments of the process, machine, manufacture, and composition of matter, means, methods and steps described in the specification.

As can be understood, the examples described herein and illustrated are intended to be exemplary only.

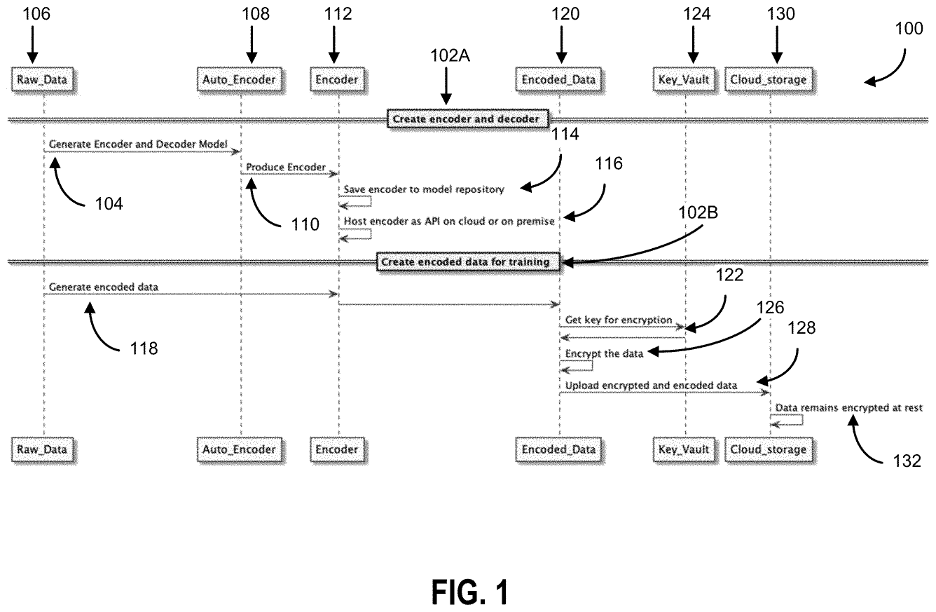

FIG. 1 shows an example process diagram of process 100 for generating encoded data for training a machine learning model, according to some embodiments. The shown steps 104, 110, 114, 116, 118, 122, 126, 128, 132 can be provided in various orders, and there may be different, or alternate steps. The steps are shown as a non-limiting example of a method according to various embodiments. In the example embodiment shown, process 100 comprises of two sub-processes, including process 102A, which describes creating an encoder and a decoder, and process 102B which describes creating encoded data for training. The process 100 for generating encoded data for training a machine learning model involves operations implemented by different hardware components. For example, the process 100 for generating encoded data for training a machine learning model can be implemented by a hardware server with one or more hardware processors.

At step 104 of process 102A, the first data set 106 (shown as the “raw data”) is provided to an auto-encoder 108. In example embodiments, the first data set 106 is organized in a tabular form, but there can different formats for the data sets. In some embodiments, for example, the raw data 106 may comprise banking data, sales data, patient data, customer data, location data, transaction data, or other personal health data, and so forth. The raw data set 106 is used to generate the encoder and decoder model.

At step 110, the auto-encoder 108 is configured to generate a first encoder 112 and a first decoder for the encoder and decoder model. The hardware server can store the first encoder 112 in non-transitory memory. Encoders 112 can be stored in an encoder repository on non-transitory storage for access and use to generate encoded data for training. The encoded data generated by the encoder can be used for training downstream machine learning models. The first encoder 112 and the first decoder may be generated simultaneously. In example embodiments, the auto encoder 108 is a tabular variational auto-encoder, configured to generate encoders configured with a first relationship machine learning model. Other encoder and decoder architectures can be used. Examples include non-variational auto-encoder and generative adversarial networks. The encoder can be hosted on cloud storage for access using an API or on premise storage, for example.

The encoder can implement a first relationship machine learning model to generate the encoded data set. The first relationship machine learning model may comprise a non-linear encoding wherein values in the raw dataset will not be the same in the encoded dataset after encoding. For example, the first relationship machine learning model may comprise a non-linear encoding wherein values in the same column on different rows will not be the same after encoding. The encoder with the first relationship machine learning model may be configured to encode data such that there is no linear relationship that successfully converts a row into its encoded counterpart. Encoding data with the first machine learning model may prevent the estimation of linear scaling mechanisms that can decode the encoded information. The encoded data can protect the sensitive data. The hardware processor can implement the encoding. The encoder can implement non-linear masking using layers.

For example, according to some example embodiments, a first row may comprise partial entries: Row 1 [0, 1, 2], and a second row may comprise partial entries Row 2: [0, 2, 4]. After encoding with the first relationship machine learning model, the example rows may become Row 1 [0.231233, 0.65, 0.423], and Row 2 [0.243523, 0.534, 0.324234]. The new row values are related to various other values in a rough approximate mapping.

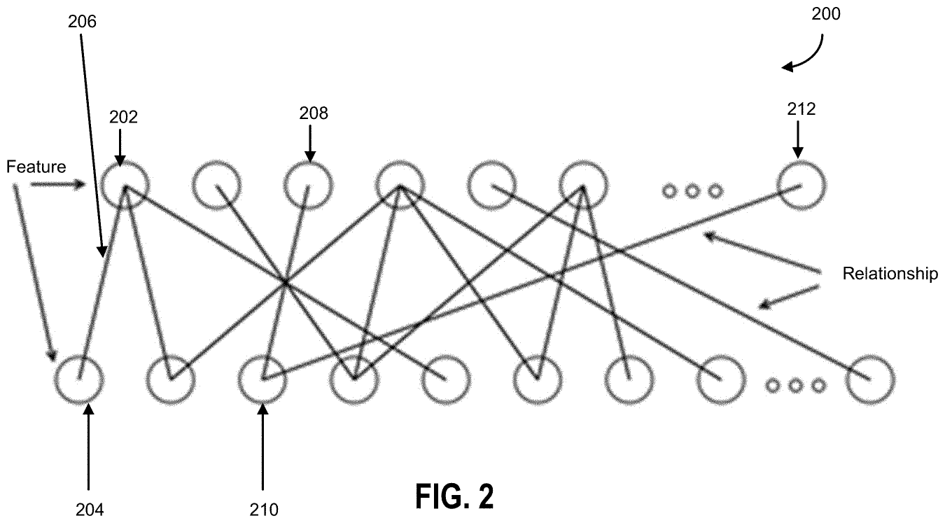

Referring now to FIG. 2, there is shown an example non-linear encoding of initial data values to encoded data values. A first initial value 202 may be related to a first new value 204 through a single relationship 206, or, according to an example embodiment, a second new value 210 may be related to multiple initial values, including second initial value 208, and third initial value 212, through various relationships. The encoded dataset can preserve the relationships of data in the initial data values.

The first decoder can be configured to decode data encoded by the first encoder 112 based on the first relationship machine learning model. The distributed system can store the decoder in a different location or resource than the encoded data to protect from unauthorized access. In example embodiments, the relationships between encoded data are maintained partly in the first encoder 112 and partly in the first decoder model generated by the auto-encoder 108.

At step 114, the hardware server stores the first encoder 112 and the first decoder. A third data set, representing the first encoder 112 and the first decoder, can be stored in non-transitory storage. In example embodiments, the first encoder 112 and the first decoder are generated by the auto-encoder 108 on a first system (alternatively referred to as the “local system”), and stored on the first system. In some embodiments, for example, the first encoder 112 and the first decoder are generated by the auto-encoder 108 on a first system, and one or any combination of the first encoder 112, the first decoder and the auto-encoder 108 are stored on a second system. The second system can be referred to as a “cloud system” for example. The cloud system can include distributed storage devices or memory.

At step 116, in accordance with some example embodiments, the first encoder 112 is configured for subsequent access to generate encoded datasets. In example embodiments, the first encoder 112 may be incorporated into an application programming interface (API), on the cloud or on a local system, and configured to encode subsequently received data with the first relationship machine learning model. The API can enable access to the encoder to receive raw data to generate encoded datasets. The encoded datasets can be used for training machine learning models. The encoded datasets can be combined with other encoded datasets (generated by the first encoder 112) to generate larger training data sets for the machine learning models. The encoded datasets can mask sensitive data.

At step 118, in process 102B, a data set 106 is processed through the first encoder 112 and encoded based on the first relationship machine learning model, thereby generating the encoded data set 120. The encoded data set 120 can be for training machine learning models. The server can store the encoded data set 120 for subsequent access to generate trained machine learning models. Encoders 112 can be stored in an encoder repository on non-transitory storage for access and use at process 102B to generate the encoded data set 120 for training. There can also be a data repository for storing the encoded data set 120 for access and use for training downstream machine learning models. The server can store the encoded data set 120 in the data repository on non-transitory storage for access and use for training. The data repository can be held on premise or reside on cloud storage to provide ease of use. The encoded data masks the raw data and protects the sensitive data, and is safer than storing the raw data.

In example embodiments, the encoded data set 120 may be encrypted to prevent unauthorized use. In some example embodiments, the encoded first data set 120 is encrypted in accordance with an encryption process which incorporates a key vault 124 storing different keys. For example, at step 122, a request for a first security is transmitted from a processor to the key vault 124, and the first security key is received from the key vault 124 to decrypt the encoded data set 120. The server can store the encrypted data in the data repository on non-transitory storage.

The key vault 124 may serve as a repository for keys used to encrypt data within an system, whereby decrypting data within a system may require authentication to access the key vault 124 to receive decrypting security keys. The key vault 124 may be stored on a first system where the first encoder 112 and the first decoder are generated, or on the second system.

At step 126, the encoded first data 120 is encrypted based on the first security key. A processor can store the encoded first data 120 for subsequent access.

At step 128, the encrypted encoded first data set may be transmitted to the second system, for example to the cloud storage 130. In example embodiments, the encrypted encoded first data set is generated on the second system. A processor can transmit the encrypted encoded first data set between storage elements within the second system.

At step 130, in example embodiments, the encrypted encoded first data set rests in cloud storage 130, and the encoded data remains encrypted until requested for a training process.

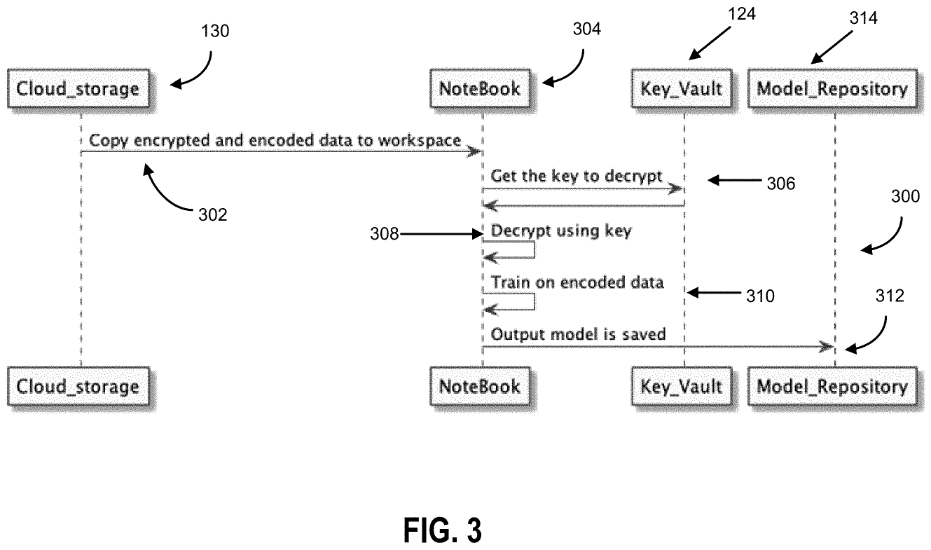

FIG. 3 shows an example process diagram of process 300 for training machine learning models, according to some embodiments. The models can be referred to downstream machine learning models. The shown steps 302, 306, 318, 310, 312 can be provided in various orders, and there may be different, or alternate steps. The steps are shown as a non-limiting example of a method according to various embodiments.

At step 302, according to some example embodiments, the encrypted encoded first data set is transmitted to a workspace 304 at a hardware server. In example embodiments, the workspace 304 is located on a system remote to the system storing the encrypted encoded first data set. In example embodiments, the workspace 304 is located within the system storing the encrypted encoded first data, and the encrypted encoded first data set is transmitted within the system between computing elements.

At step 306, the workspace 304 transmits a request for, and receives a second security key from the key vault 124. The second security key may be configured to decrypt data encrypted based on the first security key. In example embodiments, the first security key and the second security key are configured in accordance with an asymmetric key encryption scheme. In example embodiments, the first security key and the second security key are the same key and are configured in accordance with a symmetric key encryption scheme.

At step 308, the workspace 304 decrypts the encrypted encoded first data set.

At step 310, a machine learning model is trained on the encoded first data set. A hardware server can use the encoded first data set for training machine learning models. The hardware server can store the trained machine learning models in a repository on non-transitory memory.

At step 312, a second data set representing the trained machine learning model is stored. In example embodiments, the second data set is stored in a machine learning model repository 314. The machine learning model repository 314 may be hosted on premise or in cloud, on either container or virtual machine environment. The machine learning model repository 314 may be configured to store and permit access to multiple data sets representing trained machine learning models. The trained machine learning models can be generated using encoded datasets.

At step 312, a second data set representing the trained machine learning model is stored. In example embodiments, the second data set is stored in a machine learning model repository 314. The machine learning model repository 314 may be hosted on premise or in cloud, on either container or virtual machine environment. The machine learning model repository 314 may be configured to store and permit access to multiple data sets representing trained machine learning models. The trained machine learning models can be generated using encoded datasets.

The model repository 314 contains models trained with the (auto) encoded data. In some examples, trained models can belong to the organization that constructed them and the model repository 314 can associate the trained models with specific organizations. For example, a server can maintain records with entries for models and identifiers for organizations authorized to access the models. The models trained with the encoded data are safer than traditional models because they are created with the auto encoded data. The models trained with the encoded data cannot be decompiled to gain insight on the original unencoded (raw) data. The model repository 314, for optimal security, cab be held on premise. However, the model repository 314 can reside on cloud servers to provide ease of use for deployment. In some embodiments, the system can separate the auto encoded data trained models from the models trained with original data for an added level of security. The model repository 314 can be secured with role based access control, and have monthly key rotation to prevent models from being stolen or accessed without authorization.

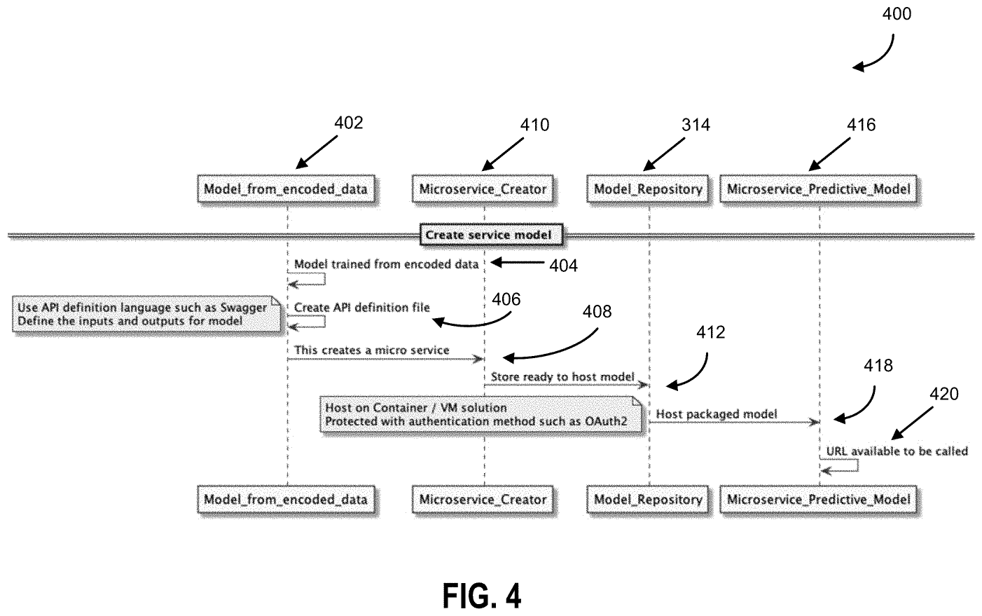

FIG. 4 shows an example process 400 for providing access to trained machine learning models. The models can be trained downstream, according to some embodiments. The shown steps 404, 406, 408, 412, 418, 420 can be provided in various orders, and there may be different, or alternate steps. The steps are shown as a non-limiting example of a method according to various embodiments.

At step 404, a machine learning model is trained based on encoded data. For example, the trained machine learning model may be trained according to process 300 shown in FIG. 3.

At steps 406, and 408 a micro service 416 may be created based on the trained machine learning model. The micro service 416 may be configured to provide subsequent users intuitive means of interacting with the trained machine learning model. For example, an API, based on the trained machine learning model, may be created to permit subsequent users to use the trained machine learning model to generate output data. The API can receive input data or requests and provide access to the trained machine learning model to generate the output data. The API can be used to exchange data without exposing the trained machine learning model, for example.

In some embodiments, for example, an API definition file may created in addition to the API in order to provide a format for describing APIs that is machine readable. For example, the API definition file may be generated using the API definition language Swagger™ combining metadata pertaining to the expected inputs and outputs of the trained machine learning model API with the machine learning model into one binary.

The API definition file can have a versioning field. An example an API versioning field is:

/<model_name>/<version>/<function handle>
/sample_model/v0.1/predict

API definition file can follow a REST API strategy.

### Create=POST

### Read=GET

### Update=PUT

### Delete=DELETE

The API definition file can http status codes:

http status codes: 1xx, 2xx, 3xx, 4xx, 5xx

An non-limiting illustrative example is:

POST /sample/model/v0.1/predict
{
address:”123 Front Street Blvd”
}

Expected return:

Status code: 200
{
estimated_price:”1100000”
}

At step 412, the micro service 416 is transmitted to a storage environment. In example embodiments, the micro service 416 is stored in the machine learning model repository 314. A server can receive requests for the micro service 416.

The micro service 416 for hosting packaged models can have different formats. The micro service 416 can be hosted on a container based system. The container system can handle networking, exposing the micro service 416 to either a private network or public network, depending on if the model is for internal or external usage. The micro service 416 can be a small set of server code, that can provide a REST API endpoint to enable user devices to interact with the model in a programmatic way. As the model is being accessed, network traffic is monitored by the micro service 416, as well as memory and other throughput metrics. The container service will scale the number of micro service 416 according to the load, to ensure a consistent response time.

At step 418, the micro service 416 is transmitted from the storage environment into an implementation environment. In example embodiments, the micro service 416 is transmitted to a micro service 416 predictive model 216 environment. In some embodiments, for example, the micro service 416 is hosted on a container or virtual machine environment.

In example embodiments the micro service is encrypted. According to some example embodiments, the micro service 416 is protected with an authentication protocol, for example the OAuth 2.0 protocol. In example embodiments, the micro service is encrypted in a manner similar to the encoded first data set.

At step 420, the implementation environment may be configured to permit access to the micro service 416. In example embodiments, the implementation environment permits access to users with the correct address for the micro service 416, for example to any user seeking to access a specific Uniform Resource Locator (URL). In example embodiments, the implementation environment may require an authenticated request to permit access to the micro service 416. For example, a user may be required to enter credentials to access the micro service 416.

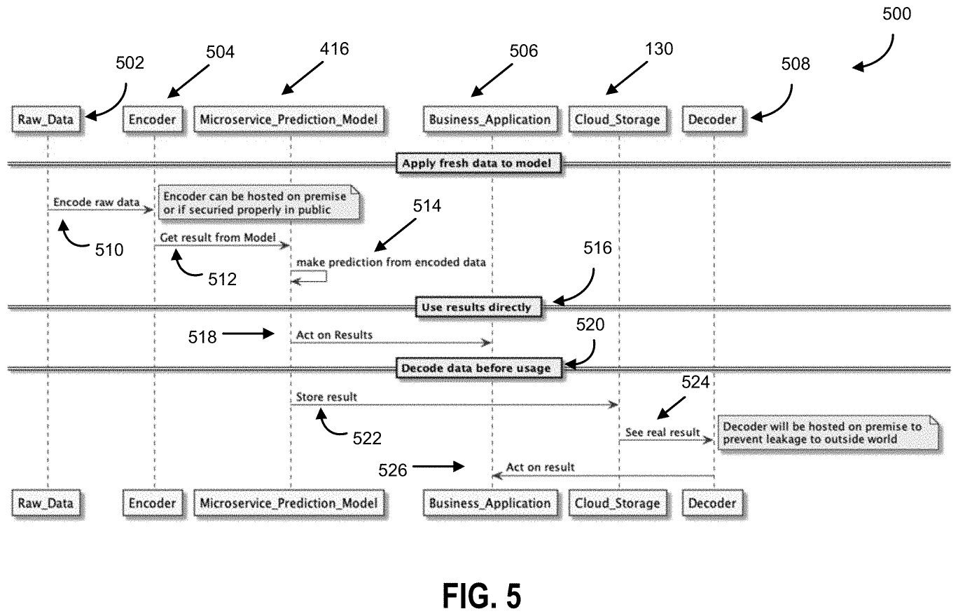

FIG. 5 shows an example process 500 diagram for providing access to machine learning models trained on encoded data, according to some embodiments. The shown steps 510-526 can be provided in various orders, and there may be different, or alternate steps. The steps are shown as a non-limiting example of a method according to various embodiments.

At step 510, a raw data set 502 is encoded using an encoder 504. In example embodiments, the data is encoded using a second encoder 504 that is generated simultaneously with the second decoder 508. Similar to the first encoder 112 and the first decoder, the second encoder 504 may be configured to encode data based on the second relationship machine learning model, and the second decoder 508 may be configured to decode data encoded by the second encoder based on the second relationship machine learning model. The term second is used herein for illustrative purposes to indicate that different data sets can be encoded using different encoders. There may be multiple datasets and multiple encoders.

In example embodiments, the second relationship machine learning model is configured to generate an encoder that also generates encoded data. The machine learning models trained on data encoded based on a first relationship machine learning mode can process data encoded using other encoders in some embodiments. For example, the second relationship machine learning model may be trained in a manner similar to the first relationship machine learning model. The encoded data generated based on the second relationship machine learning model can preserve data relationships or patterns that are meaningful relative to the raw data. For example, the second relationship machine learning model can be trained on banking data in a manner similar to the first relationship machine learning model being trained on similar banking data, with the inputs including data required for a loan application. The data required for a loan application can be encoded with the second encoder 504, and passing the encoded data required for a loan application through the trained machine learning model can generate a processed response which, when decoded by the second decoder 508, replies with “approved” or “unapproved.”

Embodiments described herein relate to encoder models. An encoder model can have both an encoder and a decoder. Embodiments described herein can use the encoder to generate the encoded data that can train downstream machine learning models. The trained model can generate output data used for predictions or classifications. Embodiments described herein can improve system security as the encoded data does not expose raw data that may have proprietary or sensitive information. The masked data protects customer data.

The encoded data can be used for training the downstream machine learning models. The training is effective as the encoded data can retain the statistical significance from the raw data. The encoder encodes data and stores the encoded data on the cloud storage. The output of the trained model can be used for predictions, classifications and other responses. In some embodiments, a decoder key can be used to decode encoded data to generate decoded data. In some embodiments, the system can use different encoders to generate encoded datasets for training.

In example embodiments, the first encoder 112 and the first decoder are the same as the second encoder 504 and the second decoder 508.

At step 512, the encoded data set is transmitted to the micro service 416 (the packed trained machine learning model) to get results from a trained model.

At step 514, the encoded data set is passed through to the micro service 416 (hosting the trained model) and processed response data (output data) is generated. The output data can be used for predictions or classifications, for example.

The application 506 can used the results directly at 516. In example embodiments, at step 518, the processed response data is transmitted to an application 506 to act on the results and implement operations based on the processed response data. For example, where the processed response data indicates that a loan should be approved, the application 506 may be configured to generate and provide documentation to complete the loan application. The application 506 can bundle models into services. Examples can include but are not limited to: estimation of property value with relationship to customer sensitive data, such as credit score; next best offer for customers; customer retention programs and attrition detection; likelihood of insurance calms based on spending patterns; and stock trading based on consumer buying habits.

In example embodiments, the processed response data is decoded before usage at 520. The decoder 508 can be used to decode the results, or a decoder key. In some embodiments, for example, the processed response data is transmitted to another system for decoding. For example, at step 522, the micro service 416 may be configured to store the processed response data at cloud storage. The processed response data may be hosted on premise or on a publicly accessible system.

At step 524, the processed response data is decoded with a (second) decoder 508. The decoded processed response data may trigger subsequent actions, as described herein. In some embodiments, the processed response data is decoded on the same system that provided the processed response data. The decoded result data may be real data or raw data. The decoder 508 can hosted on premise storage to prevent access.

At step 526, the decoded process response data may be transmitted to applications to trigger further actions. For example, where the decoded processed response data indicates that a loan should be approved, the application 506 may be configured to generate and provide documentation to complete the loan application.

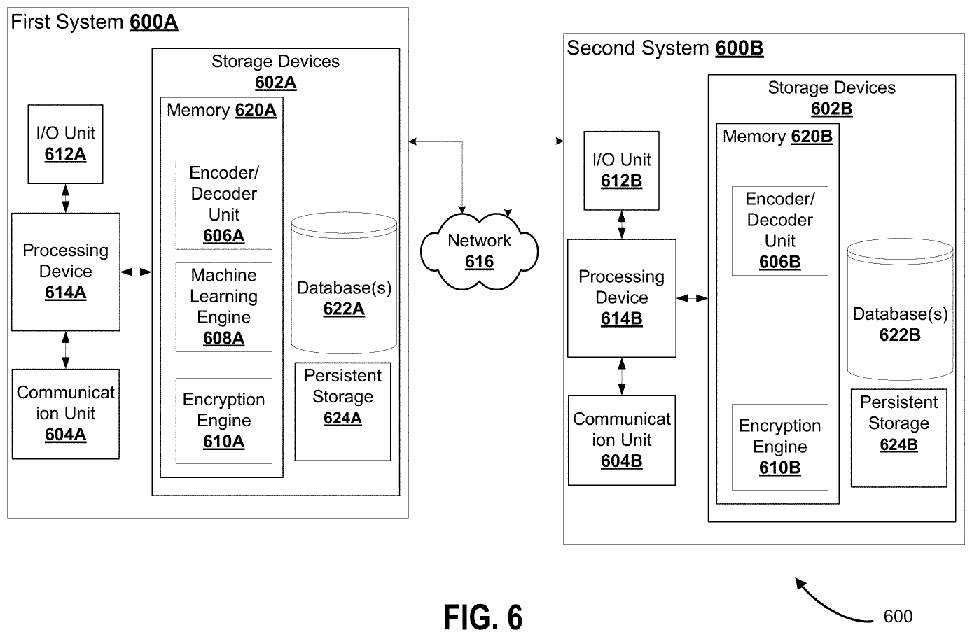

FIG. 6 is a schematic diagram showing aspects of an example computing system 600 according to some embodiments. The computing system 600 can implement aspects of the processes described herein. In some embodiments, the computing system can provide a dynamic resource environment. In some embodiments, the dynamic resource environment can be a cloud platform or a local platform on which data can be encoded and machine learning models can be trained.

The computing system 600 may comprise a first platform 600A, and a second platform 600B. Each system 600A and 600B can include an I/O Unit 612A and 612B, (hereinafter referred to as the I/O Unit in the singular) respectively, a processor 614A, and 614B, respectively, communication interface 604A, and 604B (hereinafter referred to as the communication interface in the singular), respectively, and data storage 602A, and 602B, respectively. The I/O Unit can enable the each computing system within computing system 600 to interconnect with one or more input devices, such as a keyboard, mouse, camera, touch screen and a microphone, and/or with one or more output devices such as a display screen and a speaker.

In some embodiments, each system within the computing system 600 can include one or more processors 614A and 614B at one or more physical and/or logical computing machines. In some embodiments, each system within the computing system 600 may comprise a single computer/machine/server with one or more active environments. In some embodiments, each system within the computing system 600 may include multiple processors spread across multiple physical machines and/or network locations (e.g. in a distributed computing environment). The term processor should be understood to any of these embodiments whether described in singular or plural form.

The processors 614A and 614B can execute instructions in non-transitory memories 620A and 620B, respectively, to implement aspects of processes described herein. The processors 614A and 614B can execute instructions in memories 620A and 620B, to configure a encoder/decoder units 606A and 606B, interface unit (to provide control commands to an interface application, for example), machine learning engine 608A, encryption engines 610A and 610B, and other functions described herein. The processors 614A and 614B can be, for example, any type of general-purpose microprocessor or microcontroller, a digital signal processing (DSP) processor, an integrated circuit, a field programmable gate array (FPGA), a reconfigurable processor, or any combination thereof. Hereinafter actions, operations, or processes attributed to the first system 600A or the second platform 600B are understood to be performed by the respective processors 614A and 614B.

The encoder/decoder unit 606A and 606B can, based on a first relationship machine learning model, generate encoded data sets based on raw data sets. The encoded data sets preserving data interrelationships within the raw (unencoded) data sets. The machine learning engine 608A is configured to train machine learning models based on encoded data sets. The encoded data sets do not impact performance for training the models.

The encryption engines 610A and 610B can encrypt data, for example based on asymmetric, and symmetric key encryption schemes, to prevent unwanted access of decrypted data. The encryption engines 610A and 610B may comprise respective key vaults 124, not shown, to further secure the encryption process.

Memories 620A and 620B, may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 602A and 602B can include memories 620A and 620B, databases 622A and 622B, and persistent storages 624A and 624B.

The communication interfaces 604A and 604B can enable the each system with computing system 600 to communicate with other components, to exchange data with other components, to access and connect to network resources, to serve applications, and perform other computing applications by connecting to a network 616 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Each system in the computing system 600 can be operable to register and authenticate users (using a login, unique identifier, and password for example) prior to providing access to applications, a local network, network 616 resources, other networks and network security devices. The computing system 600 may serve multiple users which may require access to sensitive data.

The data storages 602A and 602B may be configured to store information associated with or created by the components in memories 620A and 620B and may also include machine executable instructions. The data storages 602A and 602B include a storages 624A and 624B which may involve various types of storage technologies, such as solid state drives, hard disk drives, flash memory, and may be stored in various formats, such as relational databases, non-relational databases, flat files, spreadsheets, extended markup files, etc.

In example embodiments, the first platform 600A is an entity platform, such as a manufacturer controlled platform, and the second platform 600B is a cloud platform, for example an AWS™ platform.

According to example embodiments, the first platform 600A is configured to receive a first data set. In example embodiments, the processor 614A, referred to hereinafter as the first processor, is configured to retrieve the first data set from storage within the first platform 600A.

In example embodiments, the first system encoder/decoder generator 606A generates the first encoder 112 and the first decoder, encodes the first data set, and transmits, a first request including the encoded first data set to the second platform 600B.

In example embodiments, the first platform 600A transmits a first request based on the first data set to the second platform 600B. The second system encoder/decoder generator 606B generates the first encoder 112 and the first decoder and encodes the first data set.

The second platform 600B, is configured to, upon receiving the first request to train a machine learning model with the first relationship machine learning model based on the encoded first data set with the machine learning engine 608A. The second platform 600B stores the second data set representing the trained machine learning model to the second data storage 602B.

In example embodiments, the first platform 600A or the second platform 600B may be configured to store the third data set, representative of the generated first encoder 112 and first decoder. For example, where the second system generates the first encoder 112, the second platform 600B may store the third data set representative of first encoder 112 in the second data storage 602B, or transmit the third data set to the first platform 600A for storage in first data storage 602A.

The first platform 600A, via the encryption engine 610A, or the second platform 600B, via the encryption engine 610B, may be configured to encrypt the encoded first data set. For example, the second platform 600B may be configured to encrypt the encoded first data set upon receiving same.

In example embodiments, the second platform 600B encrypting the encoded first data set may comprise transmitting a request for a first security key to the first platform 600A, receiving the first security key, via the first encryption engine 610B key vault 124, encrypting the encoded first data set based on the first security key. In this process, relying upon keys generated by the first platform 600A may provide greater control to the originator of the data.

In example embodiments, the second platform 600B decrypts the encrypted encoded first data set by transmitting a request for a second security key to the first platform 600A, the second security key configured to decrypt data encrypted with the first security key, and receiving the second security key. The second platform 600B subsequently decrypts the encrypted encoded first data set.

In example embodiments, the first and second security key are located within the same system that performs encryption, and the respective keys are transmitted intrasystem.

According to some example embodiments, the first platform 600A is further configured to transmit the third data set to the second platform 600B, and the second platform 600B is further configured to receive a second input data set, encode the second input data set with the first encoder provided by the third data set to generate an encoded second input data set. The second platform 600B thereafter passes the encoded second input data set through the trained machine learning model to generate a second processed response, and stores the second processed response in the second data storage 602B.

The second platform 600B may be further configured to transmit the second processed response to the first platform 600A. The first platform 600A may be configured to decode the second processed response, via the encoder/decoder generator 606A.

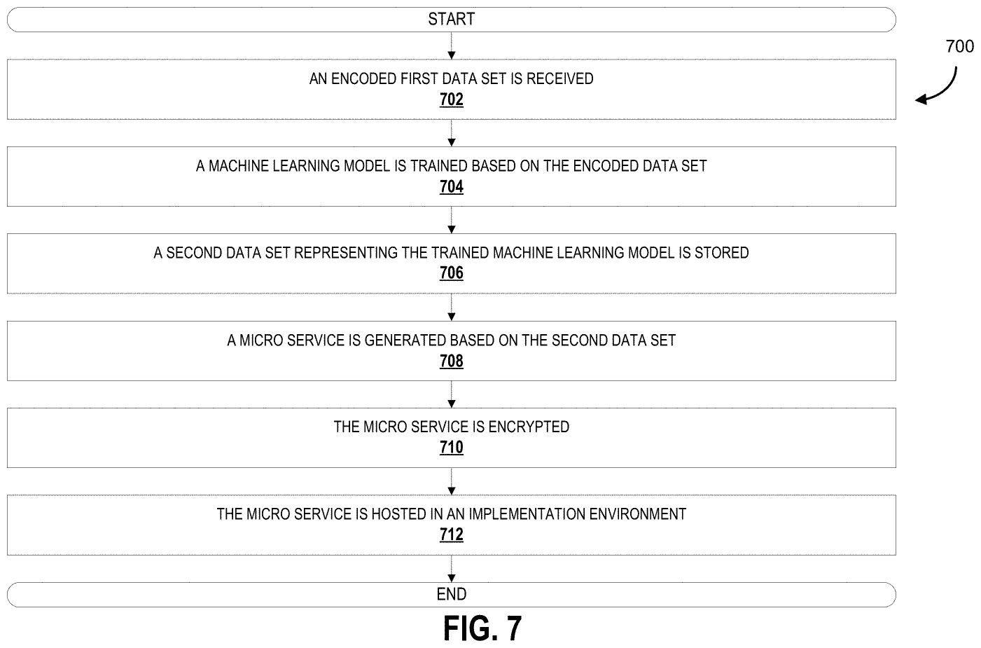

Referring now to FIG. 7, a method 700 for training a machine learning model is shown. In example embodiments, the method may be carried out by a processor located on the second platform 600B. The shown steps 702-712 can be provided in various orders, and there may be different, or alternate steps. The steps are shown as a non-limiting example of a method according to various embodiments.

At step 702, the encoded first data set is received. In example embodiments, the encoded first data set is encrypted. The encoded data set may configured be accessible in response to receiving an authenticated request to train a machine learning model, causing the encrypted encoded first data set to be decrypted.

Encrypting may comprise transmitting a request for a first security key, receiving the first security key, and encrypting the encoded first data set based on the first security key. Decrypting may comprise transmitting a request for a second security key, the second security key configured to decrypt data encrypted with the first security key, and receiving the second security key. The encrypted encoded first data set is then decrypted based on the second security key.

In example embodiments, an encoded first data set is generated. Encoding the first data set comprises generating a first encoder configured with the first relationship machine learning model to generate encoded data sets based on raw data sets, the encoded data sets preserving data interrelationships within the raw (unencoded) data sets, generating a first decoder, configured with a paired first relationship machine learning model to decode data encoded by the encoder, and encoding the first data set with the first encoder to generate the encoded first data set.

In example embodiments, a third data set is stored representing the first encoder and the first decoder.

At step 704, a machine learning machine learning model is trained based on the encoded first data set, where the encoded first data set is encoded based on a first relationship machine learning model, the first relationship machine learning model configured to generate encoded data sets based on raw data sets. The encoded data sets preserving data interrelationships within the raw data sets. The operation involves storing a second data set representing the trained machine learning model.

At step 706, the second data set representing the trained machine learning model is stored.

At step 708, the micro service 416 is generated based on the trained machine learning model. For example, the micro service 416 may be generated in accordance with the process set out in FIG. 4.

At step 710, the micro service 416 is encrypted. For example, the micro service 416 may be encrypted in accordance with the process set out in FIG. 4.

At step 712, the micro service 416 is hosted on an implementation environment. In example embodiments, the micro service 416 may be hosted in an encrypted form, and decrypted in response to an authenticated request. For example, the micro service 416 may be decrypted in accordance with the process set out in FIG. 4.

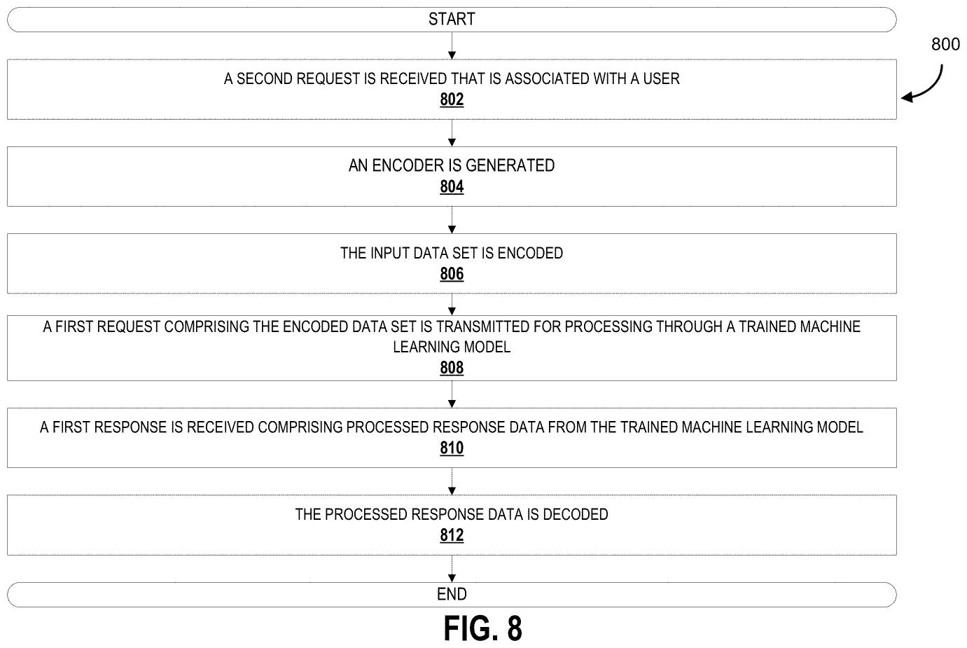

Referring now to FIG. 8, a method 800 for generating processed data is shown. The shown steps 802-812 can be provided in various orders, and there may be different, or alternate steps. The steps are shown as a non-limiting example of a method according to various embodiments.

At step 802, a second request comprising input data is received. For example, the input data may represent a loan application.

At step 804, the second encoder 504 and the second decoder 508 are generated, based on the second relationship machine learning model and the input data, the second relationship machine learning model configured to generate encoded data that interfaces with machine learning models trained on data encoded based on a first relationship machine learning model.

In example embodiments, a fourth data set representing the second encoder 504 and the second decoder 508 is stored. The fourth data set may be stored encrypted, and decrypted in response in response to receiving an authenticated request to access the fourth data set.

Similar to the encrypting process set out herein, the encrypting of the fourth data set may require a key vault and the first and second security key.

At step 806 encoded input data is generated by the second encoder 504.

At step 808, a first request is transmitted comprising the encoded input data.

At step 810, a first response is received comprising processed response data, the processed response data being generated based on the encoded input data passing through a machine learning model trained on data encoded based on the first relationship machine learning model. The processed response data may not be actionable or understandable prior to being decoded by the second decoder 508.

At step 812, the processed response data is decoded based on the second decoder 508. The decoded processed response data may be actionable or understandable. For example, the decoded processed response may comprise a response that a loan application has been approved.

FIG. 9 shows an example architecture of an encoder key 900 according to some embodiments. The example shows a high level encoder architecture for the encoder key 900 with layer type and output shape configurations. There is shown example parameters including a number of trainable parameters and non-trainable parameters.

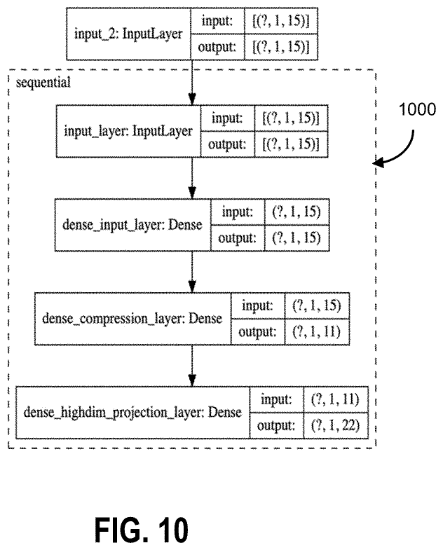

FIG. 10 shows an example architecture of an encoder key with expanded nested layers 1000, according to some embodiments. The expanded nested layers 1000 include an input layer, a dense input layer, a compression layer, and a dense high dimensional project layer as an example. Each layer receives input data and provides output data. The encoder use layers of linear and non-linear transformations. The non-linearities can be performed by different functions, for example. These form a series of non-affine transformations which are less restrictive than their linear counterparts in the encoding task resulting in a higher degree of safeguarding the data.

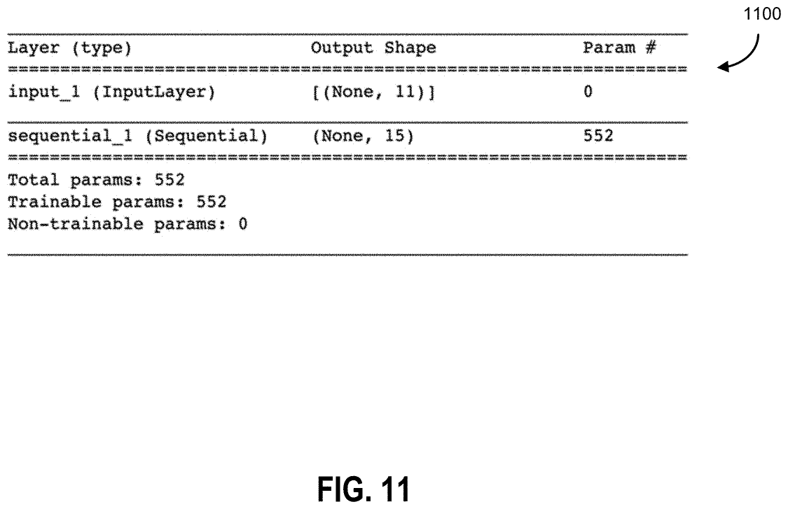

FIG. 11 shows an example architecture of a decoder key 1100 that corresponds to the example encoder key 900 shown in FIG. 9.

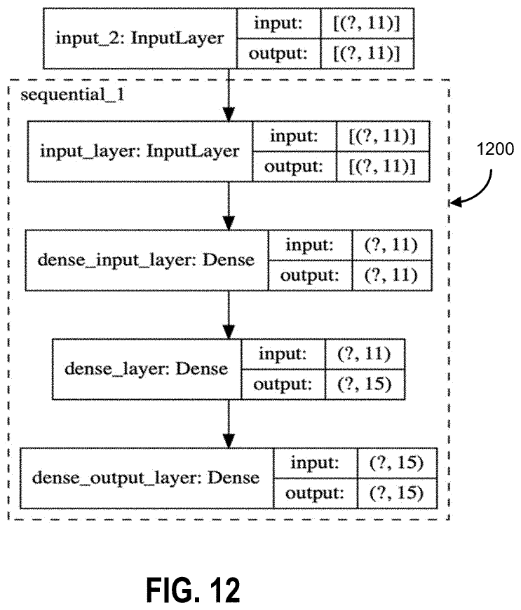

FIG. 12 shows an example architecture of a decoder key with expanded nested layers 1200. The decoder key corresponds to the example encoder key. Similar to the encoder, the expanded nested layers 1200 include an input layer, a dense input layer, a compression layer, and a dense high dimensional project layer as an example. The decoder use layers of linear and non-linear transformations. The non-linearities can be performed by different functions.

Embodiments of methods, systems, and apparatus are described through reference to the drawings.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only. Practical implementation of the features may incorporate a combination of some or all of the aspects, and features described herein should not be taken as indications of future or existing product plans. Applicant partakes in both foundational and applied research, and in some cases, the features described are developed on an exploratory basis.

What is claimed is:

1. A computer-implemented method for a server system having machine learning models, the method comprising:
generating an encoder using a hardware processor accessing a first relationship machine learning model from non-transitory memory, the first relationship machine learning model being an encoder and decoder model to generate encoded data sets based on raw data sets, the encoded data sets preserving data interrelationships within the raw data sets, the encoder for non-linear masking;
storing the encoder in an encoder repository on non-transitory storage;
encoding a first data set using the encoder to generate an encoded first data set based on the first relationship machine learning model;
storing the encoded first data set in cloud storage;
training a machine learning model based on the encoded first data set using a hardware server to access the encoded first data set stored in the cloud storage; and
storing the trained machine learning model in a model repository.

2. The method of claim 1, further comprising encrypting the encoded first data set.

3. The method of claim 2, wherein encrypting the encoded first data set comprises:
transmitting a request for a first security key,
receiving the first security key, and
encrypting the encoded first data set based on the first security key.

4. The method of claim 2, further comprising in response to receiving an authenticated request to train the machine learning model, decrypting the encrypted encoded first data set.

5. The method of claim 4, wherein decrypting the encrypted encoded first data set comprises:
transmitting a request for a second security key, the second security key configured to decrypt data encrypted with the first security key, receiving the second security key, and
decrypting the encrypted encoded first data set based on the second security key.

6. The method of claim 1, further comprising:
generating the first relationship machine learning model as the encoder and decoder model;
generating a first encoder configured with the first relationship machine learning model, and a first decoder, configured with a paired first relationship machine learning model to decode data encoded by the first encoder; and
encoding a first data set with the first encoder to generate the encoded first data set.

7. The method of claim 1, further comprising:
generating a first encoder configured with the first relationship machine learning model to generate encoded data sets based on raw data sets, the encoded data sets preserving data interrelationships within the raw data sets,
generating a first decoder, configured with a paired first relationship machine learning model to decode data encoded by the encoder, and
storing the first encoder and the first decoder.

8. The method of claim 7, further comprising transmitting the third data set and the second data set in response to an authenticated request.

9. The method of claim 1 further comprising:
encoding a second data set using the encoder to generate an encoded second data set based on the first relationship machine learning model;
storing the encoded second data set in the cloud storage; and
training the machine learning model based on the encoded second data set.

10. The method of claim 1, further comprising:
encoding input data using the encoder to generate encoded input data, wherein the encoder repository has service interface to access the encoder;
generating output data by processing the encoded input data using the trained machine learning model, wherein the model repository has an application programming interface to access the trained machine learning model; and
making a prediction or acting on the output data using an application.

11. A server system for machine learning models, the system comprising:
a hardware processor operating in conjunction with non-transitory memory, the hardware processor:
receives an encoded data set generated by an encoder using a first relationship machine learning model, the first relationship machine learning model being an encoder and decoder model to generate encoded data sets based on raw data sets, the encoded data sets preserving data interrelationships within the raw data sets, the encoder for non-linear masking;
trains a machine learning model using the encoded data set; and
stores the trained machine learning model to a model repository, the model repository having an interface to enable access and use of the trained machine learning model to generate output data.

12. The system of claim 11 wherein the other computer system encodes input data using the encoder to generate encoded input data, and generates output data by the processing the encoded input data using the trained machine learning model.

13. The system of claim 11, wherein the hardware processor:
generates the encoder configured with the first relationship machine learning model to generate encoded data sets based on raw data sets, the encoded data sets preserving data interrelationships within the raw data sets;
generates a decoder configured with a paired first relationship machine learning model to decode data encoded by the encoder;
generates the encoded first data set by processing the data set using the encoder, and
storing the encoder and the decoder.

14. A computer-implemented method for training a machine learning model, the method comprising:
training, at a first hardware processor, a machine learning model based on an encoded first data set, the encoded first data set encoded based on a first relationship machine learning model, the first relationship machine learning model configured to:
generate encoded data sets based on raw data sets, the encoded data sets preserving data interrelationships within the raw data sets, and
storing a second data set representing the trained machine learning model.

15. The method of claim 14, further comprising encrypting the encoded first data set.

16. The method of claim 15, wherein encrypting the encoded first data set comprises:
transmitting a request for a first security key,
receiving the first security key, and
encrypting the encoded first data set based on the first security key.

17. The method of claim 14, further comprising in response to receiving an authenticated request to train a machine learning model, decrypting the encrypted encoded first data set.

18. The method of claim 17, wherein decrypting the encrypted encoded first data set comprises:
transmitting a request for a second security key, the second security key configured to decrypt data encrypted with the first security key,
receiving the second security key, and
decrypting the encrypted encoded first data set based on the second security key.

19. The method of claim 14 comprising:
receiving input data;
generating encoded input data;
transmitting a first request comprising the encoded input data;
receiving a first response comprising processed response data, the processed response data generated based on the encoded input data passing through the trained machine learning model, and
decoding the processed response data based on the second relationship machine learning model.

20. The method of claim 15, wherein generating encoded input data further comprises:
generating a second encoder configured to encode data based on a second relationship machine learning model,
generating the second encoder simultaneously with generating a second decoder, the second decoder configured to decode data encoded by the second encoder, and
storing a fourth data set representing the second encoder and the second decoder.
